(19) United States
(12) Patent Application Publication
(10) Pub. No.: US 2010/0157056 A1
(43) Pub. Date: Jun. 24, 2010

(54) TRACKING AND IMAGING DATA FUSION

(75) Inventors: Ron Zohar, Yokneam Ilit (IL); David Reinitz, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL ADVANCED DEFENSE SYSTEMS LTD., HAIFA (IL)

(21) Appl. No.: 12/600,839

(22) PCT Filed: May 20, 2008
(86) PCT No.: PCT/IL08/00682

§ 371 Date: Nov. 19, 2009

(30) Foreign Application Priority Data
May 20, 2007 (IL) 083320

(51) Int. Cl. H04N 7/18; G06K 9/00; H04N 5/225

(52) U.S. Cl. 348/144; 382/103; 348/169; 348/148; 348/E07.085; 348/E05.024

(57) ABSTRACT

A method of monitoring a target, which includes tracking the target using a tracking modality, thereby obtaining an estimated track of the target, imaging the target using an imaging modality, thereby obtaining an image of the target, associating the estimated track with the image, and displaying at least one datum related to the image along with the estimated track.

### FIELD AND BACKGROUND OF THE INVENTION

The present invention relates to real-time tracking of one or more targets and, more particularly, to a data fusion method that combines results of a tracking modality such as ground moving target indicator (GMTI) radar that lacks sufficient resolution to identify the targets it tracks with results of an imaging modality, such as video motion detection (VMD), that has sufficient resolution to identify the targets.

As used herein, “tracking” a target means producing an estimate of a target's coordinates as a function of time. The estimate so produced is the “track” of the target.

GMTI is a known modality for tracking vehicles moving on the ground from an airborne platform, using Doppler radar. GMTI is an all-weather modality that can monitor vehicular movement in a region that spans tens of kilometers. Nevertheless, GMTI has several limitations. One limitation is that the resolution and the accuracy of GMTI is limited, so that GMTI cannot resolve several closely-spaced targets and cannot identify even isolated targets. Another limitation is inherent in Doppler radar. GMTI senses only a target's velocity component in-line with the Doppler radar apparatus. Therefore, GMTI loses track of a target that halts, or of a target that moves only transverse to the line from the Doppler radar apparatus to the target. GMTI also may lose track of a target that moves behind an obstacle.

VMD is another known modality for tracking vehicles moving on the ground from an airborne platform. In VMD, a digital video camera is used to acquire many successive frames that image the region being monitored. Moving targets are identified by comparing successive frames. The airborne platform caries a navigation mechanism, typically based on one or more GPS receivers and on an inertial measurement unit, for determining the aircraft's absolute position and absolute orientation in real time. This information, combined with elevation information in the form of a digital terrain map, is used to orient the video camera relative to the aircraft so that the video camera points at a desired position on the ground. This information also is combined with the orientation of the video camera relative to the aircraft when each frame is acquired and with the digital terrain map to associate a corresponding absolute position with the pixels of the frame that correspond to a moving target and so to determine the absolute position of the moving target. Alternatively, the frame is registered to an appropriate digital description of the region being monitored, for example to the digital terrain map or to a digital orthogonal photograph of the region being monitored, in order to determine the absolute position of the moving target.

The size of the region imaged in a video frame is adjustable, using a zoom lens of the video camera, from (at typical aerial platform altitudes) several kilometers at the lowest zoom setting down to on the order of several meters at the highest zoom setting. For VMD, the zoom lens typically is set to the setting such that several image pixels correspond to each target being tracked. Thus, VMD resolves individual vehicles and locates the vehicles with an accuracy of a few meters. The vehicles then can be identified according to their visual signatures. This high resolution comes at the expense of very limited areal coverage as compared with the areal coverage available using GMTI.

Another disadvantage of VMD, relative to GMTI, is that VMD needs a clear line of sight to the targets being tracked. So, for example, an aircraft that uses GMTI to track vehicles can fly above cloud cover, whereas an aircraft that uses VMD to track vehicles must fly below cloud cover.

It is known to combine GMTI with other radar measurements to identify the targets tracked using GMTI. See, for example, Erik P. Blasch and Chun Yang, “Ten methods to fuse GMTI and HRRR measurements for joint tracking and identification”, at the URL www.fusion2004.foi.se/papers/IF04-1006.pdf.

### SUMMARY OF THE INVENTION

According to the present invention there is provided a method of monitoring a target, including the steps of (a) tracking the target using a tracking modality, thereby obtaining an estimated track of the target; (b) imaging the target using an imaging modality, thereby obtaining an image of the target; (c) associating the estimated track with the image; and (d) displaying at least one datum related to the image along with the estimated track.

According to the present invention there is provided a system for monitoring a target, including: (a) a tracking subsystem for tracking the target, thereby obtaining an estimated track of the target; (b) an imaging subsystem, separate from the tracking subsystem, for imaging the target, thereby obtaining an image of the target; (c) an association mechanism for associating the estimated track with the image; and (d) a display mechanism for displaying at least one datum related to the image along with the estimated track.

According to the present invention there is provided a method of monitoring a plurality of targets, including the steps of: (a) tracking the targets using a tracking modality, thereby obtaining, for each of at least one target group that includes a respective at least one of the targets, a respective estimated track; (b) for each target group: (i) based at least in part on the respective estimated track, imaging and tracking each at least one respective target of the each target group using a combined imaging and tracking modality, thereby obtaining a respective image of each respective target, and (ii) associating the respective estimated track with the respective at least one image; and (c) selectively displaying at least one the estimated track along with, for at least one of the image that is associated therewith, at least one datum related to the each at least one image.

According to the present invention there is provided a system for monitoring a plurality of targets, including: (a) a tracking subsystem for tracking the targets, thereby obtaining, for each of at least one target group that includes a respective at least one of the targets, a respective estimated track; (b) a plurality of imaging subsystems for imaging the targets, each imaging subsystem for imaging a respective one of the targets, thereby obtaining a respective image that depicts the one target; (c) an association mechanism for associating each image with the respective estimated track of the target group that includes the target that is depicted by the each image; and (d) a display mechanism for selectively displaying at least one the estimated track along with at least one datum related to at least one of each image that is associated therewith.

According to the present invention there is provided a method of monitoring a target, including the steps of: (a) tracking the target, using a tracking modality; and (b) in response to a degradation of the tracking of the target: (i) acquiring an image of a region estimated, based at least in part on the tracking of the target, to include the target, and (ii) locating the target in the region, based at least in part on at least a portion of the image.

According to the present invention there is provided a method of monitoring at least one target, including the steps of (a) tracking a first target, thereby obtaining an estimated track of the first target; (b) acquiring an image of a first region that includes the first target; (c) associating the estimated track with the image of the first target; (d) acquiring an image of a second region; and (e) comparing at least one datum related to the image of the first region to at least one datum related to the image of the second region to determine whether the first target is depicted in the image of the second region.

According to the present invention there is provided a method of imaging a target, including the steps of: (a) obtaining an image of a region that includes the target; (b) determining coordinates of the target; (c) based at least in part on the coordinates, aiming a combined imaging and tracking modality at the target; (d) tracking and imaging the target, using the combined imaging and tracking modality; and (e) based at least in part on the tracking by the combined imaging and tracking modality, extracting, from the image, a portion of the image that depicts the target.

According to the present invention there is provided a system for imaging a target, including: (a) a tracking subsystem for tracking the target, thereby obtaining a first estimated track of the target, the first estimated track including coordinates of the target; (b) a combined imaging and tracking subsystem for imaging, according to the coordinates, a region that includes the target, and for then tracking the target, thereby providing a second estimated track of the target; and (c) an extraction mechanism for extracting, from the image, a portion of the image that depicts the target, the extracting being based at least in part on the second estimated track.

According to the present invention there is provided a method of selectively monitoring a plurality of targets, including the steps of: (a) imaging the targets, substantially simultaneously, thereby providing a respective image of each target; (b) displaying the images collectively; (c) based at least in part on visual inspection of the images, selecting one of the targets; and (d) devoting a resource to the one target.

According to the present invention there is provided a system for selectively monitoring a plurality of targets, including: (a) at least one imaging modality for substantially simultaneously imaging the targets to provide a respective image of each target; (b) a display mechanism for displaying the images collectively; (c) a selection mechanism for selecting one of the images on the display mechanism; and (d) a tracking modality for tracking the respective target of the selected image.

According to one embodiment of the present invention, a tracking modality provides an estimated track of the target and an imaging modality provides an image of the target. By “image” is meant herein either a single video frame of a region that includes the target or a plurality of such frames (e.g. a video clip). The track of the target that is estimated by the tracking modality is associated with the image of the target that is, acquired by the imaging modality, and at least one datum that is related to the image is displayed along with the estimated track. The datum or data that is/are displayed could be, for example, the image itself, a portion of the image, results of Automatic Target Recognition (ATR) processing of the image, or some other output of image processing such as the color of the target. In the examples presented herein, the data that are displayed typically are a portion of the image, possibly accompanied by textual results of the ATR processing.

Preferably, the imaging modality is a combined imaging and tracking modality. Most preferably, the imaging modality includes video motion detection. Also most preferably, in addition to being tracked by the tracking modality, the target is tracked by the combined imaging and tracking modality, and the tracking of the target by the tracking modality is corrected according to the tracking of the target by the combined imaging and tracking modality.

Preferably, the target is identified, based at least in part on at least a portion of the image of the target and on the estimated track. Most preferably, the identifying of the target provides the datum or data that is/are displayed along with the estimated track. Also most preferably, the tracking of the target by the tracking modality is corrected in accordance with the identifying of the target.

The associating includes, optionally, either mapping coordinates used by the tracking modality into coordinates used by the imaging modality or mapping coordinates used by the imaging modality into coordinates used by the tracking modality. The displaying of the at least portion of the image along with the estimated track is effected either substantially simultaneously with the associating, in real time, or subsequent to the associating. Preferably, the delayed displaying is of archived versions of the estimated track and the datum or data.

Preferably, the estimated track and the image are archived, and the datum or data that is/are displayed are provided by identifying the target, based at least in part on the archived estimated track and on at least a portion of the archived image. Most preferably, the display of the archived estimated track and of the (portion of the) archived image is effected upon the request of the operator of the system at which these data are archived.

Preferably, the imaging includes pointing the imaging modality at the target in accordance with the estimated track.

Preferably, to facilitate the imaging of the target, the imaging modality is moved (as opposed to just pointed) to an appropriate vantage point, in accordance with the estimated track. Most preferably, the imaging modality is moved by moving a platform on which the imaging modality is mounted. It often is wise to select the vantage point with reference to the target's direction of motion. Therefore, most preferably, the selection of the vantage point is performed at least in part according to the estimated track. Also most preferably, the selection of the vantage point is performed at least in part in accordance with the location of an object, for example a terrain feature such as a cliff, as determined e.g. from a digital terrain map, or an artificial structure such as a building, as determined e.g. from a digital structure map, that partly hides the target.

Preferably, the displaying is effected at a location different from the location at which the associating is effected. For this purpose, the estimated track to be displayed and its associated image-related data are transmitted to the location at which the estimated track and its associated image-related data are displayed. Most preferably, the image-related data include at least a portion of the image that depicts the target.

A corresponding system of the present invention includes a tracking subsystem that obtains an estimated track of the target, an imaging subsystem that is separate from the tracking subsystem and that obtains an image of the target, an associating mechanism for associating the tracking with the imaging and a display mechanism for displaying at least one datum that is related to the image along with the estimated track.

Preferably, the system includes at least one vehicle, such as an aircraft, on which the tracking subsystem and the imaging subsystem are mounted. More preferably, the system includes a plurality of such vehicles, and the tracking subsystem and the imaging subsystem are mounted on different vehicles. Most preferably, the system includes a wireless mechanism for exchanging, between or among the vehicles, the results of the tracking and the imaging. Also most preferably, the mechanism for associating the tracking with the imaging is distributed between or among the vehicles.

According to another embodiment of the present invention, a plurality of targets are tracked by a tracking modality, thereby obtaining, for each of one or more target groups, each of which includes a respective one or more of the targets, a respective estimated track of the target group. Based at least in part on the estimated track of its group, each target is imaged and tracked by a combined imaging and tracking modality to provide a respective image of that target, and the respective estimated track of that target's group is associated with at least a portion of that target's respective image. At least one of the estimated tracks is selected for display and is displayed along with data that are related to its associated image(s).

Preferably, the displaying is effected at a location different from the location at which the associating is effected. For this purpose, the estimated track(s) to be displayed and its/their associated image-related data are transmitted to the location at which the estimated track(s) and its/their associated image-related data are displayed. More preferably, the data that are displayed include only portions of the images. Most preferably, each image includes a plurality of frames and the data that are displayed include, for each image, only a portion of each frame of the image.

Preferably, the data that are displayed along with the selected estimated track(s) include textual information about at least a portion of at least one of the images to which the data are related. Examples of such textual information include the output of ATR processing, the color(s) of the target(s) and the size(s) of the target(s). Displaying textual information about the target(s) facilitates seeking information about the target(s) in a database.

A corresponding system of the present invention includes a tracking subsystem that obtains respective estimated tracks of the target groups; a plurality of imaging subsystems, each of which obtains an image of a respective one of the targets; an associating mechanism for associating the estimated tracks with the corresponding images; and a display mechanism for displaying each estimated track along with data that are related to the corresponding image(s). Preferably, the system also includes a plurality of vehicles, such as aircraft, and the tracking subsystem and each of the imaging subsystems is mounted on a respective vehicle.

According to yet another embodiment of the present invention, a target is tracked by a tracking modality until the tracking modality senses or predicts degradation (up to and including cessation) of its tracking of the target. Then, an image of a region that is estimated, based on the tracking, to include the target is acquired, and, based at least in part on at least a portion of the image, the target is located in the region.

Preferably, based at least in part on the locating of the target in the region, tracking of the target is resumed, for example by the original tracking modality. Alternatively, the imaging modality is a combined imaging and tracking modality, and tracking of the target is resumed using the combined imaging and tracking modality. Most preferably, the combined imaging and tracking modality includes video motion detection.

Preferably, acquiring the image of the region includes pointing an image modality, that is used to acquire the image, at the region.

Preferably, to facilitate acquiring the image of the region, an imaging modality is moved, in response to the degradation of the tracking by the tracking modality, to an appropriate vantage point. The image of the region then is acquired using that imaging modality. Most preferably, the imaging modality is moved by moving a platform on which the imaging modality is mounted. Also most preferably, the tracking by the tracking modality provides an estimated track of the target, and the selection of the vantage point is performed at least in part according to the estimated track. Also most preferably, the selection of the vantage point is performed at least in part in accordance with the location of an object that partly hides the target.

Preferably, locating the target in the region is based at least in part on a thermal contrast between the target and the region.

Also preferably, acquiring the image of the region and locating the target in the region are effected using a combined imaging and tracking modality such as video motion detection.

Also preferably, the tracking modality is a combined imaging and tracking modality, and, as part of locating the target in the region, at least one datum related to one or more images acquired by the combined imaging and tracking modality is compared to the image of the region that is estimated to include the target.

Preferably, the target is both tracked and imaged. To locate the target in the region, the image of the target that is acquired during the tracking is cross-correlated with at least a portion of the image of the region.

Also preferably, while the target is tracked, a plurality of images of the target is acquired. The images are combined, for example by averaging, and the target is located in the region by cross-correlating the combined image with at least a portion of the image of the region.

In a variant of the “resumed tracking” aspect of the present invention, along with the initial tracking of a first target, region that includes the first target also is imaged, and the resulting image is associated with an estimated track that is provided by the tracking. Preferably, the tracking and the imaging are done together, using a combined imaging and tracking modality such as VMD. Subsequently, when a second target is tracked by a combined imaging and tracking modality (either the same imaging and tracking modality or a different imaging and tracking modality that also preferably includes VMD), at least one datum related to an image acquired by one of the modalities is compared to at least one datum related to an image acquired by the other modality to determine whether the second target is actually the same as the first target. For that matter, the image of the first target need not be acquired by a combined tracking and imaging modality, but may be acquired by an imaging modality, with the purpose of the image comparison being to determine whether the target presently being tracked had been previously imaged in a different context.

Preferably, for each image, the at least one datum that is related to that image is at least a portion of the image that depicts the respective target of that image. Most preferably, the comparing of the two images includes cross-correlating those two at least portions.

The preferred method used by the present invention to obtain portions of images of targets for display along with estimated target tracks constitutes an invention in its own right. According to this invention, an image of a region that includes a target is obtained, and the coordinates of the target are determined. Based at least in part on those coordinates, a combined imaging and tracking modality is aimed at the target and is used to track and image the target. Based at least in part on the tracking by the combined imaging and tracking modality, a portion of the image that depicts the target is extracted from the image. Normally, the image of the region that includes the target is obtained as part of the tracking and imaging of the target by the combined imaging and tracking modality. Alternatively, the image of the region that includes the target is obtained, as in the variant described above of the “resumed tracking” aspect of the present invention, separately from the tracking and imaging of the target by the combined imaging and tracking modality.

Preferably, the coordinates of the target are determined using a tracking modality. Typically, the tracking modality is a modality such as GMTI that has a wider field of view than the combined imaging and tracking modality, so that the coordinates determined by the tracking modality are only approximate coordinates. The reason for using two different tracking modalities is that the wide-FOV modality can monitor a relatively large arena, within which the narrower-FOV combined imaging and tacking modality focuses on a target of interest.

Preferably, the tracking modality and the combined imaging and tracking modality produce respective estimated tracks of the target. The two tracks are associated with each other to confirm that the target being tracked by the combined imaging and tracking modality is in fact the target of interest that is tracked by the tracking modality. Most preferably, associating the two tracks includes transforming the coordinates from the coordinate system used by the tracking modality to the coordinate system used by the combined imaging and tracking modality, or alternatively transforming the coordinates from the coordinate system used by the combined imaging and tracking modality to the coordinate system used by the tracking modality.

Preferably, the steps of aiming the combined imaging and tracking modality at the target, tracking and imaging the target using the combined imaging and tracking modality, and extracting the portion of the image that depicts the target are effected only if it is first determined that the target is moving.

Preferably, the combined imaging and tracking modality includes video motion detection.

Preferably, to facilitate aiming the combined imaging and tracking modality at the target, the combined imaging and tracking modality is moved to an appropriate vantage point. Most preferably, the imaging modality is moved by moving a platform on which the imaging modality is mounted. Also most preferably, the tracking by the combined imaging and tracking modality provides an estimated track of the target, and the selection of the vantage point is performed at least in part according to the estimated track. Also most preferably, the selection of the vantage point is performed at least in part in accordance with the location of an object that partly hides the target.

A corresponding system includes a tracking system for tracking the target, thereby obtaining a first estimated track of the target that includes coordinates of the target; a combined imaging and tracking subsystem for imaging, according to the coordinates, a region that includes the target and then tracking the target, thereby providing a second estimated track of the target; and an extraction mechanism for extracting from the image a portion that depicts the target, with the extraction being based at least in part on the second estimated track.

Preferably, the system also includes an association mechanism for associating the two estimated tracks.

Preferably, the system also includes at least one vehicle, such as an aircraft, on which the tracking subsystem and the combined imaging and tracking subsystem are mounted. More preferably, the system includes a plurality of such vehicles, and the tracking subsystem and the combined imaging and tracking subsystem are mounted on different vehicles. Most preferably, the system includes a wireless mechanism for sending the first estimated track from the tracking subsystem to the combined imaging and tracking subsystem.

Preferably, the combined imaging and tracking subsystem uses video motion detection to image and track the target.

According to a final preferred embodiment of the present invention, for selectively monitoring a plurality of targets, the targets are imaged substantially simultaneously to provide a respective image of each target. The purpose of the substantially simultaneous imaging is to allow the selection for intensive monitoring, in real time, of the most interesting target from among a large collection of targets. The images are displayed collectively, for example together on a video display screen, to allow visual inspection of all the images together. Based at least in part on this visual inspection, one of the targets is selected and a resource is devoted to the selected target.

Preferably, the targets also are ranked, and the displaying is effected in accordance with that ranking. Most preferably, the ranking is effected at least in part using automatic target recognition. Note that automatic target recognition is only a most preferred feature of this embodiment of the present invention, unlike visual inspection of the images, which is obligatory.

Preferably, the imaging is effected using at least one combined imaging and tracking modality, as part of tracking of the targets.

Examples of a resource that is devoted to the selected target include a tracking modality for tracking the selected target, an imaging modality for further imaging of the selected target, a weapon for attacking the selected target, a display device for dedicated display of a location of the selected target and a mechanism for warning of the presence of the selected target.

Preferably, the imaging of the targets is effected by acquiring at least one image of at least a portion of an arena that includes the targets and extracting each target's respective image from the arena image(s) as a respective subportion of (one of) the arena image(s) that depicts that target.

A corresponding system of the present invention includes at least one imaging modality for substantially simultaneously imaging the targets to provide a respective image of each target, a display mechanism for displaying the images collectively, a selection mechanism for selecting one of the images on the display mechanism, and a resource that can be devoted to the respective target of the selected image.

### BRIEF DESCRIPTION OF THE DRAWINGS

The invention is herein described, by way of example only, with reference to the accompanying drawings, wherein:

FIG. 1 is a high level block diagram of a GMTI subsystem of the present invention;

FIG. 2 is a high level block diagram of a VMD subsystem of the present invention;

FIG. 3 illustrates a typical deployment of the subsystems of FIGS. 1 and 2;

FIG. 4 illustrates a method of associating VMD tracks with GMTI tracks;

FIG. 5 is a portion of an image acquired by the subsystem of FIG. 2, with subimages of targets outlined

FIG. 6 is a data flow diagram of one embodiment of the present invention

FIG. 7 shows a display of subframes that depict targets;

FIG. 8 shows a display of some of the subframes of FIG. 7 along with the associated estimated tracks.

### DESCRIPTION OF THE PREFERRED EMBODIMENTS

The present invention is of a data fusion method and system which can be used to track and identify moving targets. Specifically, the present invention can be used to track and identify enemy vehicles on a battlefield.

The principles and operation of data fusion according to the present invention may be better understood with reference to the drawings and the accompanying description.

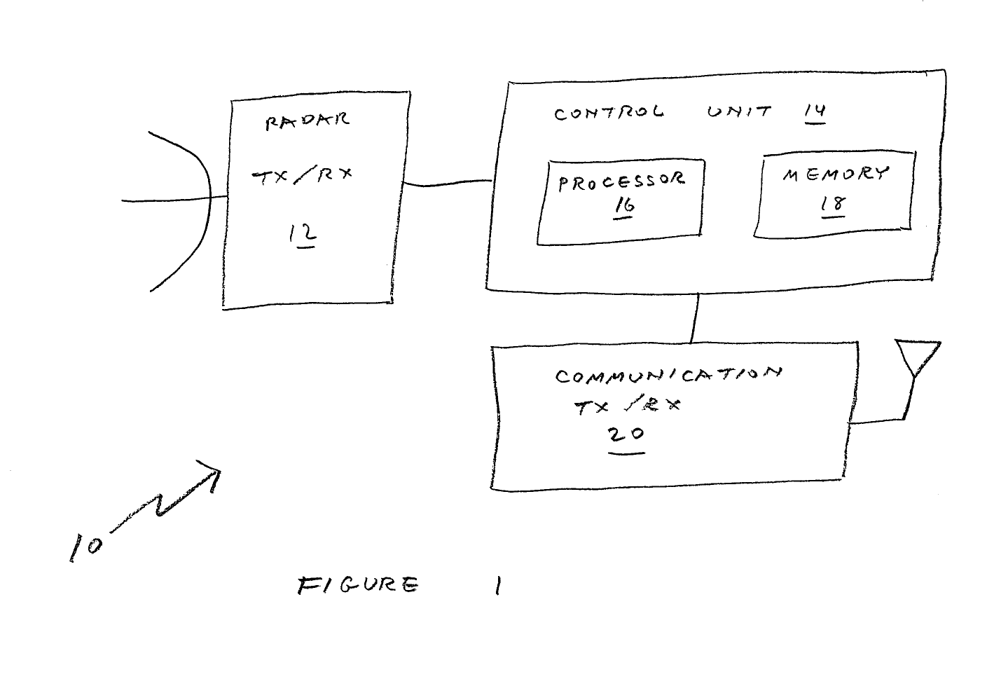

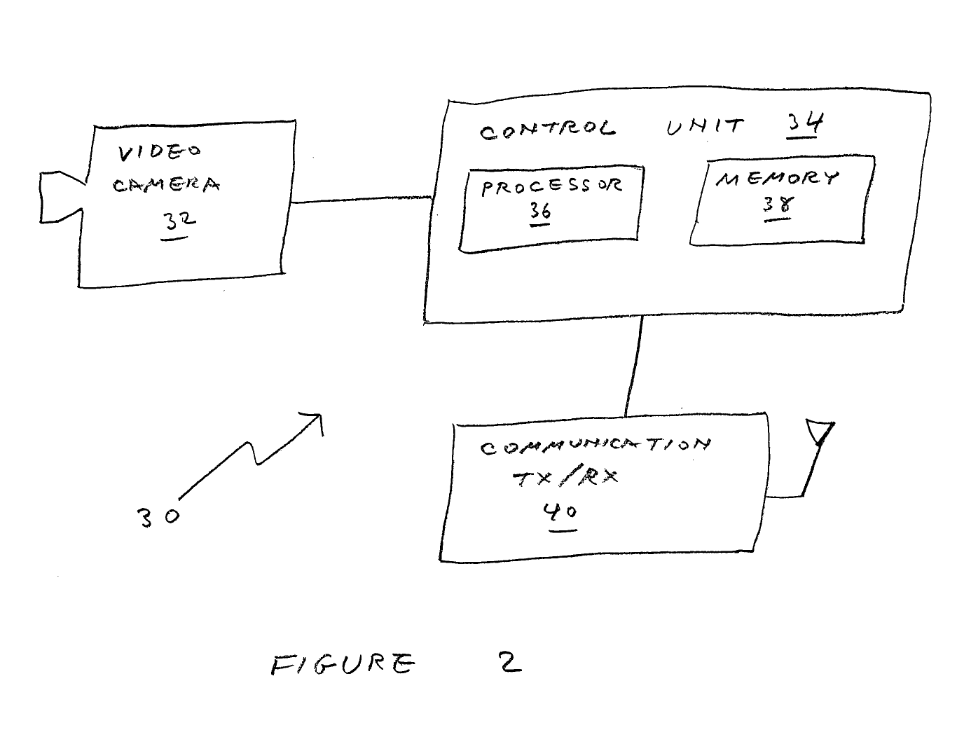

Referring now to the drawings, FIGS. 1 and 2 are high level block diagrams of, respectively, a GMTI subsystem 10 and a VMD subsystem 30 of the present invention.

GMTI subsystem 10 includes components found in a prior art GMTI system: a radar transceiver 12 and a control unit 14. Control unit 14 includes, among other subcomponents, a processor 16 and a memory 18. Memory 18 is used to store conventional GMTI software for aiming radar transceiver 12 at regions of interest and for processing data received from radar transceiver 12 to track targets. This GMTI software is executed by processor 16 and the resulting tracks are stored in memory 18. Memory 18 also is used to store software that, when executed by processor 16, implements the method of the present invention as described below.

VMD subsystem 30 includes components found in a prior art VMD system: a gimbal-mounted digital video camera 32 and a control unit 34. Control unit 34 includes, among other subcomponents, a processor 36 and a memory 38. Memory 38 is used to store conventional VMD software for aiming video camera 32 at regions of interest and for processing data received from video camera 32 to track and identify targets. This VMD software is executed by processor 36 and the resulting tracks and target identities are stored in memory 38. Memory 38 also is used to store software that, when executed by processor 36, implements the method of the present invention as described below.

Note that the implementation of the method of the present invention is distributed between control units 14 and 34. To facilitate this sharing of responsibilities, subsystems 10 and 30 include respective RF communication transceivers 20 and 40 for exchanging data. For example, control unit 14 of subsystem 10 uses communication transceiver 20 to transmit GMTI tracks to subsystem 30; control unit 34 of subsystem 30 uses communication transceiver 40 to receive these GMTI tracks and aims video camera 32 accordingly as described below.

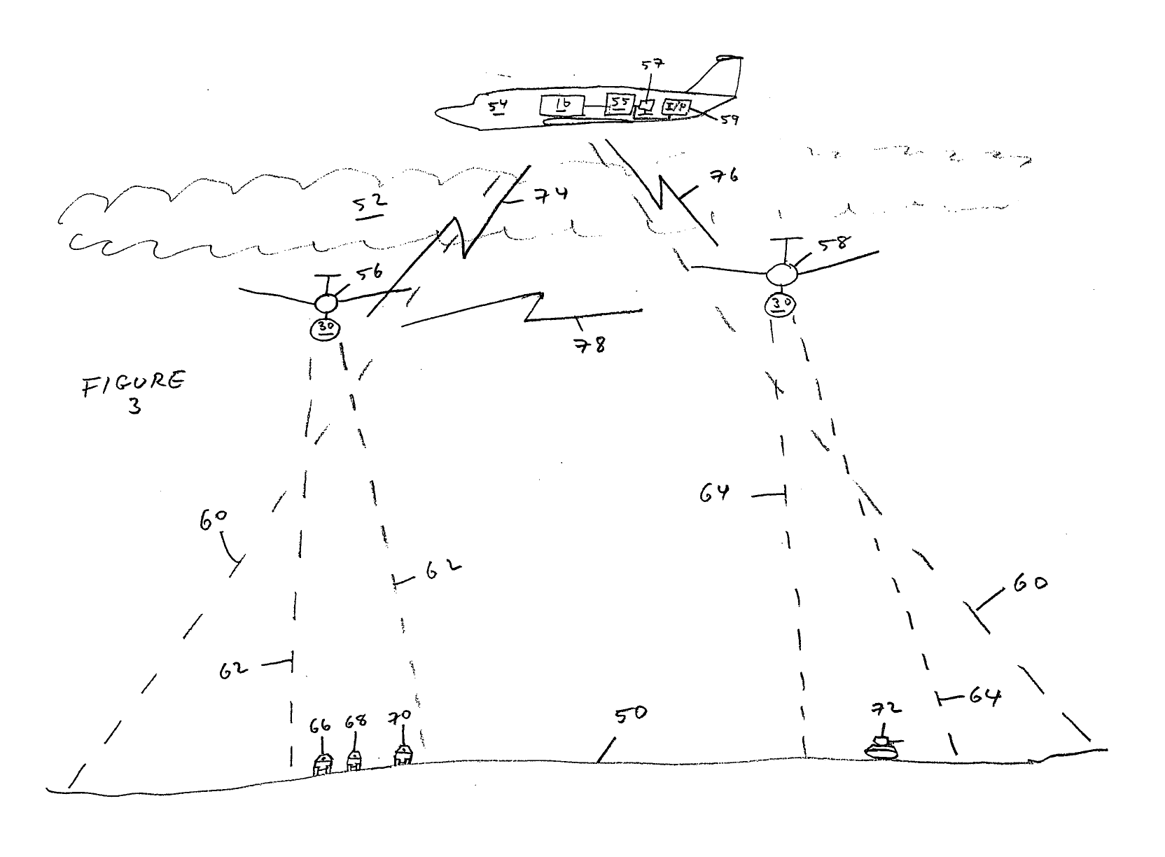

FIG. 3 shows a typical method of deploying the combined system 10 and 30 of the present invention. Specifically, in the illustrated example the combined system is deployed above a battlefield 50 on which move enemy vehicles 66, 68, 70 and 72. One subsystem 10 is mounted on an aircraft 54. Two subsystems 30 are mounted on respective aircraft 56 and 58. For illustrational clarity, subsystems 30 are shown mounted in pods underneath the fuselages of their respective aircraft 56 and 58. More commonly, subsystems 30 are mounted within the fuselages of their respective aircraft 56 and 58, just as subsystem 10 is mounted within the fuselage of aircraft 54 as shown. Aircraft 54, with GMTI subsystem 10, flies above a cloud cover 52. Aircraft 56 and 58, with VMD subsystems 30, fly below cloud cover 52. Typically, aircraft 56 and 58 are unmanned. Aircraft 54 may be either manned or unmanned. Zigzag lines 74, 76 and 78 represent RF signals exchanged by communication transceivers 20 and 40 of subsystems 10 and 30. These RF signals represent the data derived by subsystems 10 and 30 in the course of tracking and identifying enemy vehicles 66, 68, 70 and 72. These RF signals also represent periodic transmissions of the respective locations of aircraft 54, 56 and 58, as determined by navigation systems (not shown) on board aircraft 54, 56 and 58.

A first preferred embodiment of the present invention now will be described. The primary purpose of this preferred embodiment is to exploit the high resolution of narrow-FOV VMD, relative to GMTI, to facilitate the identification of moving targets tracked by GMTI.

According to this first preferred embodiment. GMTI subsystem 10 of aircraft 54 monitors vehicular movement at relatively low resolution over a relatively wide portion of battlefield 50. The field of view of GMTI subsystem 10 of aircraft 54 is indicated in FIG. 3 by two bounding dashed lines 60. In this example, GMTI subsystem 10 of aircraft 54 acquires and tracks enemy vehicles 66, 68, 70 and 72 and transmits the GMTI tracks that its control unit 14 estimates for enemy vehicles 66, 68, 70 and 72 to VMD subsystems 30 of aircraft 56 and 58. VMD subsystem 30 of aircraft 56, recognizing that aircraft 56 is closer than aircraft 58 to enemy vehicles 66, 68 and 70, aims its video camera 32 at enemy vehicles 66, 68 and 70 according to their coordinates as estimated by GMTI subsystem 10 and then tracks enemy vehicles 66, 68 and 70. The field of view of VMD subsystem 30 of aircraft 56 is indicated in FIG. 3 by two bounding dashed lines 62. This field of view is considerably narrower than the field of view of GMTI subsystem 10 of aircraft 54. VMD subsystem 30 of aircraft 56 associates the VMD tracks that it estimates for enemy vehicles 66, 68 and 70 with the corresponding estimated GMTI tracks that it received from GMTI subsystem 10 of aircraft 54. VMD subsystem 30 of aircraft 58, recognizing that aircraft 58 is closer than aircraft 56 to enemy vehicle 72, aims its video camera 32 at enemy vehicle 72 according to its coordinates as estimated by GMTI subsystem 10 and then tracks enemy vehicle 72. The field of view of VMD subsystem 30 of aircraft 58 is indicated in FIG. 3 by two bounding dashed lines 64. This field of view also is considerably narrower than the field of view of GMTI subsystem 10 of aircraft 54. VMD subsystem 30 of aircraft 58 associates the VMD track that it estimates for enemy vehicle 72 with the corresponding estimated GMTI track that it received from GMTI subsystem 10 of aircraft 54.

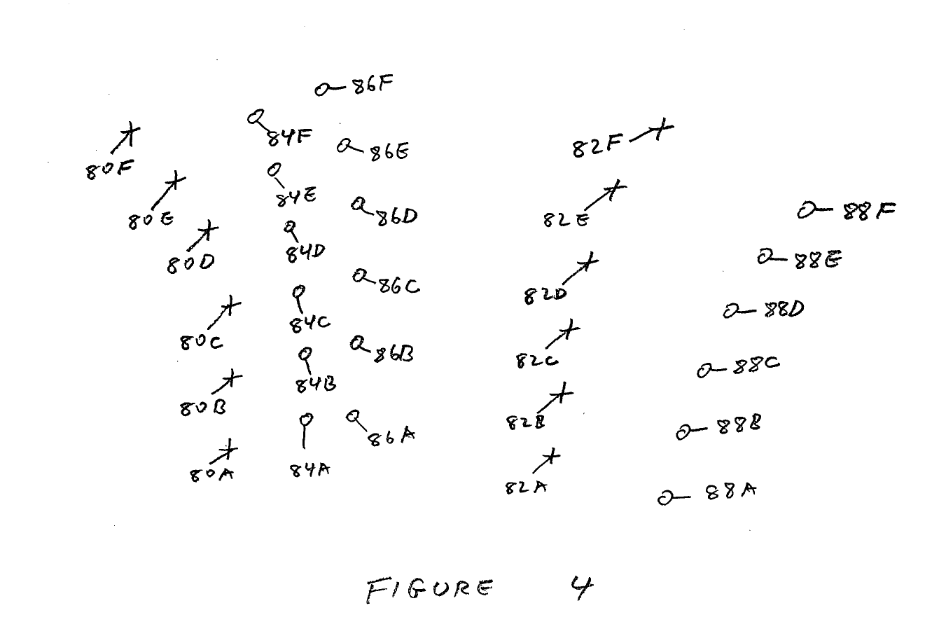

FIG. 4 illustrates one method that VMD subsystem 30 of aircraft 56 uses to associate the estimated VMD tracks it derives with the estimated GMTI tracks received from GMTI subsystem 10 of aircraft 54. Specifically, FIG. 4 is a plan view of the portion of battlefield 50 that lies within the field of view of VMD subsystem 30 of aircraft 56. “+”s 80A through 80F mark the coordinates of enemy vehicles 66 and 68 as estimated by GMTI subsystem 10 of aircraft 54 at successive times t_{A} through t_{F}. Note that the resolution of GMTI subsystem 10 is too coarse to distinguish enemy vehicle 66 from enemy vehicle 68, so both enemy vehicles are assigned the same coordinates 80. Coordinates 80 constitute an estimated GMTI track of enemy vehicles 66 and 68. Similarly, “+”s 82A through 82F mark the coordinates of enemy vehicle 70 as estimated by GMTI subsystem 10 of aircraft 54 at times t_{A} through t_{F}. Coordinates 82 constitute an estimated GMTI track of enemy vehicle 70. “o”s 84A through 84F mark the coordinates of enemy vehicle 66 as estimated by VMD subsystem 30 of aircraft 56 at times t_{A} through t_{F}. Coordinates 84 constitute an estimated VMD track of enemy vehicle 66. “o”s 86A through 86F mark the coordinates of enemy vehicle 68 as determined by VMD subsystem 30 of aircraft 56 at times t_{A} through t_{F}. Coordinates 86 constitute an estimated VMD track of enemy vehicle 66. “o”s 88A through 88F mark the coordinates of enemy vehicle 70 as estimated by VMD subsystem 30 of aircraft 56 at times t_{A} through t_{F}. Coordinates 88 constitute an estimated VMD track of enemy vehicle 70.

A priori, VMD subsystem 30 of aircraft 56 does not know which of its estimated VMD tracks 84, 86 and 88 to associate with estimated GMTI track 80 and which of its estimated VMD tracks 84, 86 and 88 to associate with estimated GMTI track 82. So VMD subsystem 30 of aircraft 56 uses known algorithms to compare estimated VMD tracks 84, 86 and 88 to estimated GMTI tracks 80 and 82 on the basis of mutual similarities. In this example, tracks 80, 84 and 86 all represent vehicles turning to the left and tracks 82 and 88 both represent vehicles turning to the right, so VMD subsystem 30 of aircraft 56 associates estimated VMD tracks 84 and 86 with estimated GMTI track 80 and associates estimated VMD track 88 with estimated GMTI track 82. VMD subsystem 30 of aircraft 56 also uses cluster association algorithms such as the algorithms taught in co-pending IL Patent Application No. 162852, entitled “DATA FUSION BY CLUSTER ASSOCIATION”, to associate two enemy vehicles 66 and 68 with a single estimated GMTI track 80.

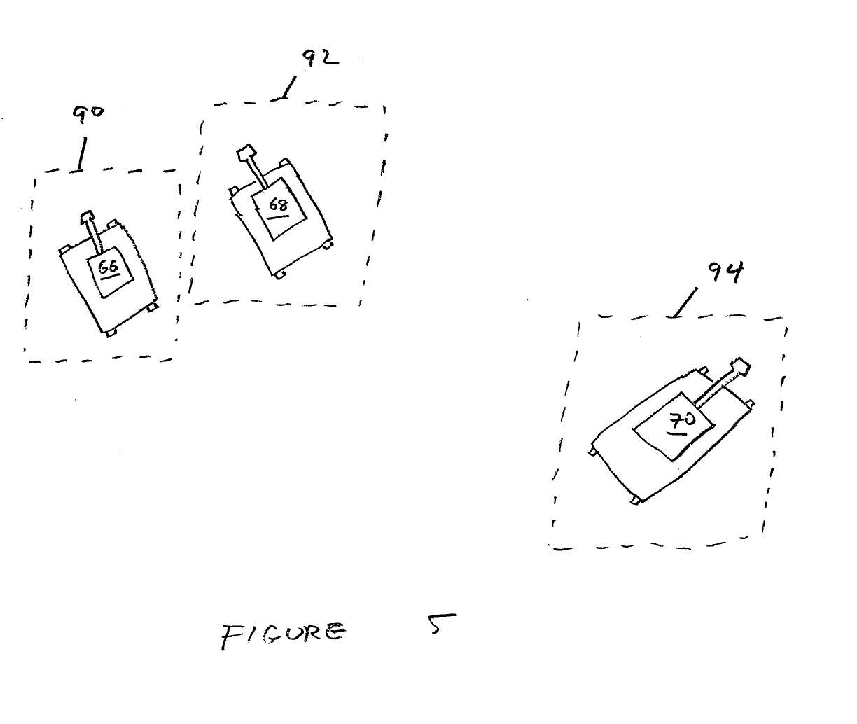

FIG. 5 shows a portion of the video frame acquired by VMD subsystem 30 of aircraft 56 at time t_{F}. VMD subsystem 30 of aircraft 56 extracts from this frame three subframes: a subframe 90 that includes the pixels of the larger frame that represent enemy vehicle 66, a subframe 92 that includes the pixels of the larger frame that represent enemy vehicle 68 and a subframe 94 that includes the pixels of the larger frame that represent enemy vehicle 70. VMD subsystem 30 of aircraft 56 flags subframes 90 and 92 as being associated with estimated GMTI track 80 and flags subframe 94 as being associated with estimated GMTI track 82. VMD subsystem 30 of aircraft 56 then transmits subframes 90, 92 and 94 to GMTI subsystem 10 of aircraft 54.

Alternatively and optionally, if the frame acquired by VMD subsystem 30 of aircraft 56 at time t_{F} is not at the highest resolution (i.e., not at the narrowest FOV) available to VMD subsystem 30 of aircraft 56, VMD subsystem 30 of aircraft 56 zooms in on enemy vehicles 66, 68 and 70, flags the resulting frames as being associated with the corresponding GMTI tracks 80 or 82, and transmits the resulting frames to GMTI subsystem 10 of aircraft 54.

Control unit 14 of GMTI subsystem 10 of aircraft 54 compares subframes 90, 92 and 94 to a template library that is stored in its memory 18 and also compares estimated GMTI tracks 80 and 82 to a database of enemy vehicle properties that is stored in memory 18 to tentatively identify enemy vehicles 66, 68 and 70. Based on these tentative identifications, control unit 14 of GMTI subsystem 10 of aircraft 54 adjusts the parameters (e.g., Kalman filter parameters) of the algorithms that control unit 14 of GMTI subsystem 10 of aircraft 54 uses to estimate GMTI tracks 80 and 82. GMTI subsystem 10 of aircraft 54 also transmits estimated GMTI tracks 80 and 82 along with the associated subframes 90, 92 and 94 to a command and control center, where estimated GMTI tracks 80 and 82 are displayed to a field commander along with subframes 90, 92 and 94 and the associated tentative identifications of enemy vehicles 66, 68 and 70. Typically, the command and control center is on the ground, but optionally the command and control center is on board aircraft 54. (In the example illustrated in FIG. 3, the command and control center is on board aircraft 54, and is illustrated schematically as a command and control computer 55 operationally connected to GMTI subsystem 10, as a display terminal 57, operationally connected to command and control computer 55, on which estimated GMTI tracks 80 and 82 and subframes 90, 92 and 94 are displayed, and as an input unit 59 such as a computer mouse for selecting subframes that are displayed on display terminal 57 as described below in the context of a second preferred embodiment of the present invention). Because the probability that the tentative identifications made by control unit 14 of GMTI subsystem 10 of aircraft 54 are correct often is inadequate for operational requirements, optionally, the field commander performs visual identifications of enemy vehicles 66, 68 and 70 as depicted in subframes 90, 92 and 94. If any of those visual identifications differ from the corresponding tentative identifications, the field commander transmits the correct identification(s) back to GMTI subsystem of aircraft 54.

The field commander also optionally prioritizes enemy vehicles to be tracked. More system resources are devoted to tracking high priority enemy vehicles than to tracking low priority enemy vehicles.

Note that strictly speaking, for the purposes of visually identifying targets associated with GMTI tracks and flagging displays of those tracks with corresponding subframes, it is not necessary for VMD subsystems 30 to perform tracking for more than two frames. (At least two frames are required because a VMD subsystem 30 recognizes targets within its field of view by comparing successive images. This also implies that only moving targets can be visually identified.) For example, if a VMD subsystem 30 recognizes a single moving object in its field of view, then the corresponding subframe is associated with the GMTI track without tracking the target. If the contrast between the target tracked by GMTI and its background is sufficiently great in the spectral band used by the VMD subsystem 30 (e.g. if video camera 32 acquires images in the thermal infrared and if the target of interest is known to be significantly warmer than its background), it often is not even necessary for the VMD subsystem 30 to acquire more than a single frame to capture a subframe of the target.

VMD subsystem 30 of aircraft 56 also transmits to GMTI subsystem 10 of aircraft 54 estimated VMD tracks 84, 86 and 88 and their associations with estimated GMTI tracks 80 and 82. GMTI subsystem 10 of aircraft 54 uses estimated VMD tracks 84, 86 and 88 to correct the estimation of GMTI tracks 80 and 82. For example, in FIG. 4, estimated GMTI track 80 is biased to the left of estimated VMD tracks 84 and 86, and estimated GMTI track 82 is biased to the left of estimated VMD track 88. Because GMTI is inherently less accurate than VMD, GMTI subsystem 10 of aircraft 54 assumes that estimated VMD tracks 84, 86 and 88 are closer to the truth than estimated GMTI tracks 80 and 82, and moves estimated GMTI tracks 80 and 82 rightward accordingly.

Even after VMD subsystem 30 of aircraft 56 has transmitted subframes 90, 92 and 94 to GMTI subsystem 10 of aircraft 54, VMD subsystem 30 of aircraft 56 continues to track enemy vehicles 66, 68 and 70 and to transmit its estimated coordinates of enemy vehicles 66, 68 and 70 to GMTI subsystem 10 of aircraft 54 so that GMTI subsystem 10 of aircraft 54 can continue to correct random and systematic errors in its GMTI estimation algorithms.

Meanwhile, VMD subsystem 30 of aircraft 58 tracks enemy vehicle 72 and sends the associated subframe and estimated VMD track to GMTI subsystem 10 of aircraft 54. The associated data processing and data exchanges are as described above for VMD subsystem 30 of aircraft 56, except that with only one enemy vehicle 72 to track, the association of a GMTI track with a VMD track is trivial.

In the above description of the first preferred embodiment, it was assumed that aircraft 56 has a clear view of enemy vehicles 66, 68 and 70 and that aircraft 58 has a clear view of enemy vehicle 72. If, for example, VMD subsystem 30 of aircraft 56 determines, based on the location of aircraft 56 and the estimated tracks of enemy vehicles 66, 68 and 70, and optionally based also on other information such as a digital terrain map stored in memory 38 of VMD subsystem 30 of aircraft 56, that a different location of aircraft 56 would provide a better vantage point than the present location of aircraft 56 for capturing images of vehicles 66, 68 and 70, then VMD subsystem 30 instructs aircraft 56 to fly to the location with the superior vantage point.

Optionally, the command and control center assigns more than one VMD subsystem 30 to track one or more targets. The aircraft bearing those VMD subsystems 30 fly to suitable vantage points for capturing images of the target(s) from several points of view. Using the resulting subframes of images of the target(s), from different respective points of view, in the procedure described above for identifying the target(s), enhances the robustness of that procedure.

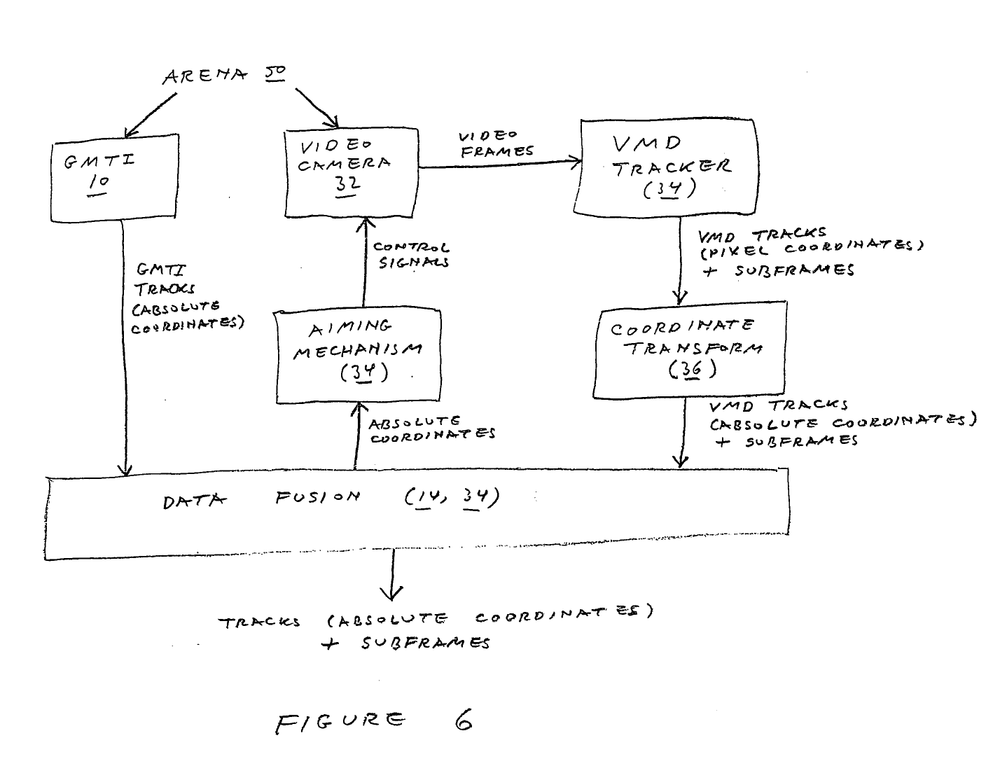

FIG. 6 is a data flow diagram of this embodiment of the present invention. The functional modules represented by boxes in FIG. 6 are labeled with the reference numerals of the corresponding components of subsystems 10 and 30. Note in particular that the data fusion function of the present invention is distributed between subsystems 10 and 30, and could be performed by control unit 14 of GMTI subsystem 10 or by control unit 34 of VMD subsystem 30 or cooperatively by both control units. Alternatively, the data fusion function of the present invention is performed at the command and control center rather than by subsystems 10 and 30.

An arena (in the above example, battlefield 50) is monitored by GMTI subsystem 10 and by video camera 32 of VMD subsystem 30. GMTI subsystem 10 provides GMTI tracks, in absolute coordinates, to the data fusion module, which sends the absolute coordinates to control unit 34. Control unit 34 sends control signals to video camera 32 to aim video camera 32 at the targets according to the absolute coordinates that control unit 34 received from the data fusion module. Video camera 32 outputs video frames to control unit 34. Control unit 34 processes these video frames to produce VMD tracks in pixel coordinates, along with associated subframes. Processor 36 of control unit 34 transforms the pixel coordinates to absolute coordinates and sends the transformed tracks and the associated subframes back to the data fusion module. Finally, the data fusion module associates the two kinds of tracks and sends them, along with the associated subframes, to command and control computer 55 for display.

A second preferred embodiment of the present invention is directed at enabling the identification, as desired, of the most interesting of a large number of moving targets that are being tracked.

According to the corresponding prior art method, when an operator of a low-resolution tracking system, for example a GMTI system on an airborne platform, sees a track of interest, s/he directs a separate, independent imaging system, for example a video system on another airborne platform, to monitor the target of interest. The video system sends a video stream to the operator, who identifies the target visually from a real-time display of the video stream. This prior art method is feasible when a relatively small number of targets are tracked by the low resolution tracking system, but not when a relatively large number of targets are tracked simultaneously by the low-resolution tracking system. Among the problems encountered in the selective tracking of a large number of targets by the prior art method is the lack of sufficient bandwidth to transmit all the video streams of all the targets of interest.

According to the second preferred embodiment of the present invention, the tracking of all the GMTI targets is supplemented by tracking using VMD subsystems 30, in order to acquire target subframes. As discussed above, each GMTI track may have several VMD tracks associated with it, reflecting the fact that a VMD subsystem 30 may resolve several targets where GMTI subsystem 10 sees only one combined target. Each VMD subsystem 30 tracks its target(s) and sends the following, from each video frame of each target that VMD subsystem 30 acquires, to GMTI subsystem 10:

The time when the frame was acquired.

The absolute position and orientation of digital video camera 32 when the frame was acquired.

The subframe, within the larger frame, of the target.

The pixel coordinates of the target within the larger frame.

The emphasis in this second embodiment of the present invention is on reducing the resources needed to monitor a large number of targets and to select relatively high-interest targets for intensive tracking. The resources that are conserved by the present invention include the number of imaging systems needed, the bandwidth needed for transmitting video streams and the number of operators needed at the command and control center (which, like the command and control center of the first embodiment, typically is on the ground but optionally is on board aircraft 54).

To reduce the bandwidth of the video transmissions to the command and control center, instead of transforming the pixel coordinates of the target to absolute coordinates for comparison with an estimated GMTI track received from GMTI subsystem 10, as in the first preferred embodiment, each VMD subsystem 30 performs its tracking in pixel coordinates and transmits the pixel coordinates to GMTI subsystem 10. GMTI subsystem 10 transforms the absolute target coordinates of its own GMTI track of the target(s) to the equivalent pixel coordinates and then associates the transformed GMTI track with the VMD track(s) in pixel coordinates as described above for the first preferred embodiment. If the command and control center is on the ground, GMTI subsystem 10 transmits the GMTI track of the target(s) to the command and control center along with the subframes of the target(s). Because only subframes are transmitted, this embodiment of the present invention requires much less bandwidth than the corresponding prior art method.

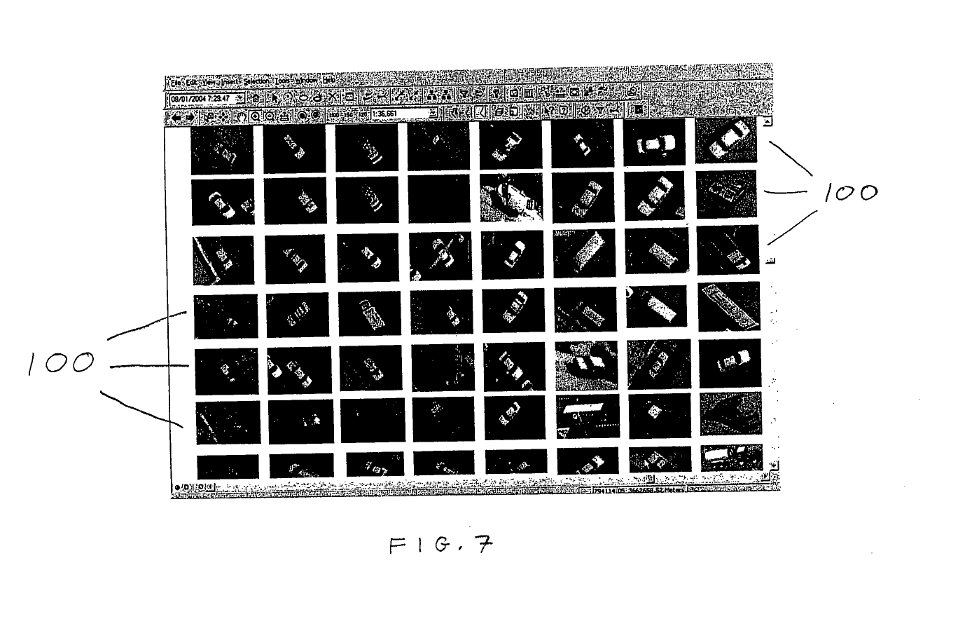

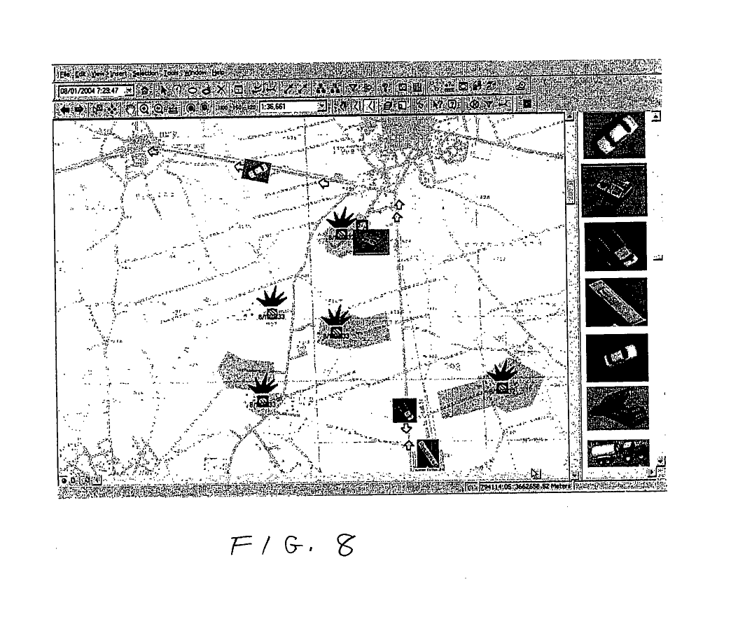

The subframes thus acquired are displayed collectively to an operator of the system of FIG. 3 using, e.g., display terminal 57. FIG. 7 shows an example of one such display of subframes 100. An operator of the system of FIG. 3 then selects a target of interest by selecting the associated subframe 100, using, e.g., input unit 59, and commands the system of FIG. 3 to display that subframe 100 along with its associated estimated track on a map of the arena being monitored. FIG. 8 shows an example of such a display. In this embodiment of the present invention, targets of interest are selected visually, rather than via automatic target recognition, although automatic target recognition optionally is used to rank subframes 100 for display in the display of FIG. 7.

To reduce the number of VMD subsystems 30 needed, each VMD subsystem 30 is multiplexed among several targets until an operator selects a target of interest. When a target of interest is selected, one of VMD subsystems 30 is dedicated to tracking that target.

The following quantitative example illustrates the advantage of the second embodiment of the present invention over the corresponding prior art method. In this example it is assumed that 1500 targets need to be monitored in order to identify the most interesting targets for intensive monitoring and tracking, and that this identification needs to be done within one minute.

In the baseline prior art method, it is assumed that it takes an operator three seconds to decide whether a target is interesting. An operator therefore can make 20 such decisions per minute. Therefore, 75 operators are needed to evaluate all 1500 targets. A separate imaging system is dedicated to each operator. If the video stream bandwidth that is dedicated to one operator is 200 Kbits/second, a total video bandwidth of 15 Mbits/second is needed.

According to the present invention, 50 subframes 100 are displayed collectively as shown in FIG. 7. If it takes 10 seconds for one operator to evaluate the 50 subframes 100 and to select the most interesting subframe 100, then one operator can evaluate 300 targets per minute, so that only five operators are needed to evaluate all 1500 targets. Each VMD subsystem 30 tracks 20 targets. To refresh the display of 50 targets once every 10 seconds, each VMD subsystem 30 devotes 0.5 seconds to tracking each of its assigned targets, and five VMD subsystems 30 contribute to two collective displays of 50 subframes 100. Only thirteen VMD subsystems 30 then are needed to feed video streams to five operators, for a total video bandwidth of only 2.5 Mbits/second if full frames are transmitted, and only 50 Kbits/second if only subframes 100 are transmitted as described above.

A third preferred embodiment of the present invention addresses a problem inherent in many tracking systems: a single tracking modality often loses track of the targets that it tracks. For example, for the reasons described in the Field and Background section (targets halting, moving transversely or becoming obscured), both a prior art GMTI system and a GMTI subsystem 10 of the present invention typically track any particular moving target for no more than a few minutes.

Therefore, when GMTI subsystem 10 of aircraft 54 stops tracking one of enemy vehicles 66, 68, 70 or 72, one of VMD subsystems 30 (typically the closest VMD subsystem 30) points its video camera 32 at the last known position of the missing enemy vehicle, or alternatively at a position predicted by extrapolating the last several known positions of the missing enemy vehicle. That VMD subsystem 30 acquires a video frame of its field of view of battlefield 50 and, based on the subframes of the enemy vehicles that are shared among VMD subsystems 30, attempts to locate the missing enemy vehicle in the field of view, for example by seeking pixels in the video frame that resemble the pixels of the subframe of the missing enemy vehicle. In one procedure, for seeking such pixels in the video frame, that is preferred because of its simplicity, the subframe is cross-correlated with the video frame, and a sufficiently high cross-correlation peak is presumed to identify the missing enemy vehicle in the video frame. If that VMD subsystem's video camera 32 is a thermal infrared camera, then the identification of the missing enemy vehicle in the video frame is made easier by the fact that a recently mobile vehicle tends to be hotter than its surroundings and so has a high contrast against its background in an infrared image. If that VMD subsystem 30 succeeds in locating the missing enemy vehicle in its field of view, then that VMD subsystem 30 tracks the missing vehicle.

Optionally, that VMD subsystem 30 also transmits the new estimated VMD track to GMTI subsystem 10 of aircraft 54. If, according to the new estimated VMD track, the missing vehicle is still moving, GMTI subsystem 10 of aircraft 54 attempts to acquire a new target at the transmitted VMD locations. When GMTI subsystem 10 of aircraft 54 succeeds in re-acquiring and tracking the missing vehicle, joint tracking resumes as described above. Continued joint tracking is useful e.g. for verifying that the target now being tracked is indeed the target that GMTI subsystem 10 lost track of.

The track recovery procedure of the third preferred embodiment need not wait for GMTI subsystem 10 of aircraft 54 to actually lose track of one of enemy vehicles 66, 68 or 70. Optionally and preferably, GMTI subsystem 10 invites one of VMD subsystems 30 to join in tracking one or more of vehicles 66, 68 or 70 when GMTI subsystem 10 recognizes existing or immanent degradation in the quality of the tracking performed by GMTI subsystem 10. For example, such an invitation may be triggered by the error bounds computed by the track estimation algorithm of GMTI subsystem 10 exceeding predetermined thresholds, or by GMTI subsystem 10 determining that one of enemy vehicles 66, 68 or 70 is coming to a halt, or by GMTI subsystem 10 determining, with reference to a digital terrain map stored in memory 18 of GMTI subsystem 10, that one of enemy vehicles 66, 68 or 70 is about to enter a topographic feature such as a ravine that obscures that enemy vehicle 66, 68 or 70 from GMTI subsystem 10.

In the above exemplary description of the third embodiment of the present invention, initial tracking is performed by GMTI subsystem 10. The scope of the third embodiment of the present invention includes initial tracking by a combined imaging and tracking modality such as VMD subsystem 30. The VMD subsystem 30 that seeks to resume tracking of the lost target acquires a video frame of its field of view of battlefield 50 and compares that video frame, as described above, to the relevant subframes of the target that were acquired by the VMD subsystem 30 that lost track of the target prior to losing track of the target.

A fourth preferred embodiment of the present invention also reduces the bandwidth needed for joint tracking of targets by a tracking modality and an imaging modality, particularly if the command and control center is based on the ground. According to this preferred embodiment, the subframes of the targets (e.g., subframes 90, 92 and 94 of the first embodiment) are not displayed along with the estimated GMTI tracks in real time. Instead, the subframes are archived in memories 38 of VMD subsystems 30, along with appropriate metadata such as time stamps that allow the command and control computer subsequently display the estimated GMTI tracks along with the associated subframes. Later, the subframes are transmitted to the command and control center for display. That the subframes need not be transmitted in real time allows the subframes to be transmitted at a slower rate, and hence in a lower bandwidth channel, than is required in the real time embodiments of the present invention.

The distribution of data processing among subsystems 10 and 30 as described above is only exemplary. In any given scenario, the data processing is distributed among subsystems 10 and 30 in whatever manner is most efficient.

While the invention has been described with respect to a limited number of embodiments, it will be appreciated that many variations, modifications and other applications of the invention may be made.

What is claimed is:

1. A method of monitoring a target, comprising the steps of:
(a) tracking the target using a tracking modality, thereby obtaining an estimated track of the target;
(b) imaging the target using an imaging modality, thereby obtaining an image of the target;
(c) associating said estimated track with said image; and
(d) displaying at least one datum related to said image along with said estimated track.

2. The method of claim 1, wherein said tracking modality includes ground moving target indicator radar.

3. The method of claim 1, wherein said tracking modality includes signals intelligence.

4. The method of claim 1, wherein said tracking modality includes at least one electro-optical sensor.

5. The method of claim 1, wherein said tracking modality includes a plurality of sensors and a data fusion mechanism for analyzing data acquired by said sensors.

6. The method of claim 1, wherein said imaging modality is a combined imaging and tracking modality.

7. The method of claim 6, wherein said combined imaging and tracking modality includes video motion detection.

8. The method of claim 6, further comprising the steps of:
(e) tracking the target using said combined imaging and tracking modality; and
(f) correcting said tracking by said tracking modality according to said tracking by said combined imaging and tracking modality.

9. The method of claim 1, further comprising the step of:
(e) identifying the target, based at least in part on at least a portion of said image.

10. The method of claim 9, wherein said identifying provides said at least one datum.

11. The method of claim 9, further comprising the step of:
(f) correcting said tracking of the target by said tracking modality in accordance with said identifying.

12. The method of claim 9, wherein said identifying is based in part on said estimated track.

13. The method of claim 1, wherein said image is a single frame.

14. The method of claim 1, wherein said image is a plurality of frames.

15. The method of claim 1, wherein said associating includes mapping coordinates used by said tracking modality into coordinates used by said imaging modality.

16. The method of claim 1, wherein said associating includes mapping coordinates used by said imaging modality into coordinates used by said tracking modality.

17. The method of claim 1, wherein said displaying is effected substantially simultaneously with said associating.

18. The method of claim 1, wherein said displaying is effected subsequent to said associating.

19. The method of claim 18, further comprising the step of:
(e) archiving said estimated track and said at least one datum, said displaying being effected subsequent to said archiving.

20. The method of claim 19, wherein said displaying is effected upon request of an operator of a system whereat said estimated track and said at least one datum are archived.

21. The method of claim 1, further comprising the steps of:
(e) archiving said estimated track and said image; and
(f) identifying the target, based at least in part on at least a portion of said image as archived, thereby providing said at least one datum.

22. The method of claim 21, wherein said identifying is based in part on said estimated track as archived.

23. The method of claim 1, wherein said imaging includes pointing said imaging modality at the target in accordance with said estimated track.

24. The method of claim 1, further comprising the step of:
(e) moving said imaging modality, in accordance with said estimated track, to a vantage point that facilitates said imaging.

25. The method of claim 24, wherein said moving is effected by steps including moving a platform whereon said imaging modality is mounted.

26. The method of claim 24, wherein said vantage point is selected at least in part in accordance with said estimated track.

27. The method of claim 24, wherein said vantage point is selected at least in part in accordance with a location of at least one object that partly hides the target.

28. The method of claim 1, wherein said displaying is effected at a location different from where said associating is effected, the method further comprising the step of:
(e) transmitting said estimated track along with said at least one datum that is associated therewith to said location where said displaying is effected.

29. The method of claim 1, wherein said at least one datum includes at least a portion of said image that depicts the target.

30. A system for monitoring a target, comprising:
(a) a tracking subsystem for tracking the target, thereby obtaining an estimated track of the target;
(b) an imaging subsystem, separate from said tracking subsystem, for imaging the target, thereby obtaining an image of the target;
(c) an association mechanism for associating said estimated track with said image; and
(d) a display mechanism for displaying at least one datum related to said image along with said estimated track.

31. The system of claim 30, further comprising:
(e) at least one vehicle on which said tracking subsystem and said imaging subsystem are mounted.

32. The system of claim 31, comprising a plurality of said vehicles, with said tracking subsystem and said imaging subsystem being mounted on respective said vehicles.

33. The system of claim 32, further comprising:
(f) a wireless mechanism for exchanging, between said vehicles, results of said tracking and said imaging.

34. The system of claim 32, wherein said mechanism for associating said estimated track with said image is distributed between said vehicles.

35. The system of claim 31, wherein said at least one vehicle is an aircraft.

36. A method of monitoring a plurality of targets, comprising the steps of:
(a) tracking the targets using a tracking modality, thereby obtaining, for each of at least one target group that includes a respective at least one of the targets, a respective estimated track;
(b) for each said target group:
(i) based at least in part on said respective estimated track, imaging and tracking each said at least one respective target of said each target group using a combined imaging and tracking modality, thereby obtaining a respective image of each said respective target, and
(ii) associating said respective estimated track with said respective at least one image; and
(c) selectively displaying at least one said estimated track along with, for at least one of said image that is associated therewith, at least one datum related to said each at least one image.

37. The method of claim 36, wherein said displaying is effected at a location different from where said associating is effected, the method further comprising the step of:
(d) transmitting said at least one estimated track along with said at least one datum that is associated therewith to said location where said displaying is effected.

38. The method of claim 37, wherein, for each said estimated track that is selectively displayed, for each said image that is associated therewith, said at least one datum includes only a portion of said image.

39. The method of claim 38, wherein, for each said estimated track that is selectively displayed, each said image that is associated therewith includes a plurality of frames and said at least one datum that is related to said each image includes only a portion of each said frame.

40. The method of claim 36, wherein, for each of at least one said image that is associated with said at least one estimated track that is displayed, said at least one datum includes textual information about at least a portion of said each at least one image.

41. A system for monitoring a plurality of targets, comprising:
(a) a tracking subsystem for tracking the targets, thereby obtaining, for each of at least one target group that includes a respective at least one of the targets, a respective estimated track;
(b) a plurality of imaging subsystems for imaging the targets, each imaging subsystem for imaging a respective one of the targets, thereby obtaining a respective image that depicts said one target;
(c) an association mechanism for associating each said image with said respective estimated track of said target group that includes the target that is depicted by said each image; and
(d) a display mechanism for selectively displaying at least one said estimated track along with at least one datum related to at least one of each said image that is associated therewith.

42. The system of claim 41, further comprising:
(e) a plurality of vehicles, said tracking subsystem and said imaging subsystem being mounted on respective said vehicles.

43. The system of claim 42, wherein said vehicles are aircraft.

44. A method of monitoring a target, comprising the steps of:
(a) tracking the target, using a tracking modality; and
(b) in response to a degradation of said tracking of the target:
(i) acquiring an image of a region estimated, based at least in part on said tracking of the target, to include the target, and
(ii) locating the target in said region, based at least in part on at least a portion of said image.

45. The method of claim 44, wherein said tracking modality includes ground moving target indicator radar.

46. The method of claim 44, wherein said tracking modality includes signals intelligence.

47. The method of claim 44, wherein said tracking modality includes at least one electro-optical sensor.

48. The method of claim 44, wherein said tracking modality includes a plurality of sensors and a data fusion mechanism for analyzing data acquired by said sensors.

49. The method of claim 44, further comprising the step of:
(c) based at least in part on said locating the target in said region, resuming said tracking of the target.

50. The method of claim 49, wherein said resuming of said tracking is effected using said tracking modality.

51. The method of claim 49, wherein said acquiring of said image is effected using a combined imaging and tracking modality and wherein said resuming of said tracking is effected using said combined imaging and tracking modality.

52. The method of claim 51, wherein said combined imaging and tracking modality includes video motion detection.

53. The method of claim 44, wherein said acquiring includes pointing an imaging modality, that effects said acquiring, at said region.

54. The method of claim 44, further comprising the step of:
(c) in response to said degradation of said tracking of said target, moving an imaging modality to a vantage point that facilitates said acquiring, said acquiring then being effected using said imaging modality.

55. The method of claim 54, wherein said moving is effected by steps including moving a platform whereon said imaging modality is mounted.

56. The method of claim 54, wherein said tracking estimates an estimated track of the target, and wherein said vantage point is selected at least in part in accordance with said estimated track.

57. The method of claim 54, wherein said vantage point is selected at least in part in accordance with a location of at least one object that partly hides the target.

58. The method of claim 44, wherein said locating is based at least in part on a thermal contrast between the target and said region.

59. The method of claim 44, wherein said acquiring and said locating is effected using a combined imaging and tracking modality.

60. The method of claim 59, wherein said combined imaging and tracking modality includes video motion detection.

61. The method of claim 44, further comprising the step of:
(c) imaging the target using an imaging modality;
and wherein said locating is effected by steps including comparing at least one datum related to an image acquired using said combined tracking and imaging modality with said image of said region that is estimated to include the target.

62. The method of claim 61, wherein said imaging modality is a combined imaging and tracking modality that is used to effect said tracking.

63. The method of claim 44, further comprising the step of:
(c) during said tracking, acquiring an image of the target;
and wherein said locating is effected by steps including cross-correlating at least a portion of said image of the target with said at least portion of said image of said region.

64. The method of claim 44, further comprising the steps of:
(c) during said tracking, acquiring a plurality of images of the target; and
(d) combining said plurality of images of the target {e.g. by averaging} to provide a combined image of the target;
and wherein said locating is effected by steps including cross-correlating at least a portion of said combined image of the target with said at least portion of said image of said region.

65. A method of monitoring at least one target, comprising the steps of:
(a) tracking a first target, thereby obtaining an estimated track of said first target;
(b) acquiring an image of a first region that includes said first target;
(c) associating said estimated track with said image of said first target;
(d) acquiring an image of a second region; and
(e) comparing at least one datum related to said image of said first region to at least one datum related to said image of said second region to determine whether said first target is depicted in said image of said second region.

66. The method of claim 65, wherein said tracking of said first target, said acquiring of said image of said first region and said associating of said image of said first region with said estimated track are effected using a combined imaging and tracking modality.

67. The method of claim 66, wherein said combined imaging and tracking modality includes video motion detection.

68. The method of claim 65, wherein said image of said second region is acquired prior to said tracking of said first target.

69. The method of claim 65, wherein said image of said second region is acquired while tracking a second target using a combined imaging and tracking modality, and wherein said comparing is to determine whether said first and second targets are identical.

70. The method of claim 69, wherein said combined imaging and tracking modality includes video motion detection.

71. The method of claim 65, wherein said at least one datum related to said image of said first region is at least a portion of said image of said first region that depicts said first target, and wherein said at least one datum related to said image of said second region is at least a portion of said image of said second region that depicts a second target.

72. The method of claim 71, wherein said comparing is effected by steps including cross-correlating said at least portion of said image of said first region with said at least portion of said image of said second region.

73. A method of imaging a target, comprising the steps of:
(a) obtaining an image of a region that includes the target;
(b) determining coordinates of the target;
(c) based at least in part on said coordinates, aiming a combined imaging and tracking modality at the target;
(d) tracking and imaging the target, using said combined imaging and tracking modality; and
(e) based at least in part on said tracking by said combined imaging and tracking modality, extracting, from said image, a portion of said image that depicts the target.

74. The method of claim 73, wherein said obtaining is effected by said combined imaging and tracking modality during said tracking and imaging of the target.

75. The method of claim 73, wherein said determining of said coordinates is effected using a tracking modality.

76. The method of claim 75, wherein said tracking modality and said combined imaging and tracking modality produce respective estimated tracks of the target, the method further comprising the step of:
(f) associating said estimated tracks.

77. The method of claim 76, wherein said tracking modality and said combined imaging and tracking modality use different respective coordinate systems, and wherein said associating includes transforming said coordinates from said coordinate system of said tracking modality to said coordinate system of said combined imaging and tracking modality.

78. The method of claim 76, wherein said tracking modality and said combined imaging and tracking modality use different respective coordinate systems, and wherein said associating includes transforming said coordinates from said coordinate system of said combined imaging and tracking modality to said coordinate system of said tracking modality.

79. The method of claim 73, further comprising the step of:
(f) determining whether the target is moving, said aiming, tracking, imaging and extracting being effected only if the target is moving.

80. The method of claim 73, wherein said combined imaging and tracking modality includes video motion detection.

81. The method of claim 73, further comprising the step of:
(f) moving said combined imaging and tracking modality, in accordance with said coordinates, to a vantage point that facilitates said aiming.

82. The method of claim 81, wherein said moving is effected by steps including moving a platform whereon said imaging modality is mounted.

83. The method of claim 81, wherein said tracking of the target estimates an estimated track of the target, and wherein said vantage point is selected at least in part in accordance with said estimated track.

84. The method of claim 81, wherein said vantage point is selected at least in part in accordance with a location of at least one object that partly hides the target.

85. A system for imaging a target, comprising:
(a) a tracking subsystem for tracking the target, thereby obtaining a first estimated track of the target, said first estimated track including coordinates of the target;
(b) a combined imaging and tracking subsystem for imaging, according to said coordinates, a region that includes the target, and for then tracking the target, thereby providing a second estimated track of the target; and
(c) an extraction mechanism for extracting, from said image, a portion of said image that depicts the target, said extracting being based at least in part on said second estimated track.

86. The system of claim 85, further comprising:
(d) an association mechanism for associating said first and second estimated tracks.

87. The system of claim 85, further comprising:
(d) at least one vehicle on which said tracking subsystem and said combined imaging and tracking subsystem are mounted.

88. The system of claim 87, comprising a plurality of said vehicles, with said tracking subsystem and said combined imaging and tracking subsystem being mounted on respective said vehicles.

89. The system of claim 88, further comprising:
(e) a wireless mechanism for sending said first track from said tracking subsystem to said combined imaging and tracking subsystem.

90. The system of claim 87, wherein said at least one vehicle is an aircraft.

91. The system of claim 85, wherein said combined imaging and tracking subsystem uses video motion detection to track and image the target.

92. A method of selectively monitoring a plurality of targets, comprising the steps of:
(a) imaging the targets, substantially simultaneously, thereby providing a respective image of each target;
(b) displaying said images collectively;
(c) based at least in part on visual inspection of said images, selecting one of the targets; and
(d) devoting a resource to said one target.

93. The method of claim 92, further comprising the step of:
(e) ranking the targets;
said displaying then being effected in accordance with said ranking.

94. The method of claim 93, wherein said ranking is effected at least in part using automatic target recognition.

95. The method of claim 92, wherein said imaging is effected using at least one combined imaging and tracking modality during tracking of said targets.

96. The method of claim 92, wherein said resource includes a tracking modality for tracking said one target.

97. The method of claim 92, wherein said resource includes an imaging modality for further imaging of said one target.

98. The method of claim 92, wherein said resource includes a weapon for attacking said one target.

99. The method of claim 92, wherein said resource includes a display device for dedicated display of a location of said one target.

100. The method of claim 92, wherein said resource includes a mechanism for warning of a presence of said one target.

101. The method of claim 92, wherein said imaging is effected by steps including:
(i) acquiring at least one image of at least a portion of an arena that includes the targets; and
(ii) for each target, extracting, from said at least one image of said at least portion of said arena, a respective subportion, of said at least one image of said at least portion of said arena, that depicts said each target, said respective extracted subportion then being said respective image of said each target that is displayed.

102. A system for selectively monitoring a plurality of targets, comprising:
(a) at least one imaging modality for substantially simultaneously imaging the targets to provide a respective image of each target;
(b) a display mechanism for displaying said images collectively;
(c) a selection mechanism for selecting one of said images on said display mechanism; and
(d) a resource for devoting to said respective target of said selected image.
